(19) United States
(12) Patent Application Publication
(10) Pub. No.: US 2006/0190425 A1
(43) Pub. Date: Aug. 24, 2006

(54) Method for merging multiple ranked lists with bounded memory

(76) Inventors: Yuan-Chi Chang, New York, NY (US); Christian Alexander Lang, New York, NY (US); Apostol Ivanov Natsev, White Plains, NY (US); Sriram K. Padmanabhan, San Jose, CA (US); Min Wang, Cortlandt Manor, NY (US); Ioana Roxana Stanoi, White Plains, NY (US)

Correspondence Address: George A. Willinghan, III;Attorney-At-Law, Suite 350, 3201 New Mexico Avenue, NW, Washington, DC, 20016, US

(21) Appl. No.: 11/064,605

(22) Filed: Feb. 24, 2005

(51) Int. Cl. G06F 17/30

(52) U.S. Cl. 707/2

(57) ABSTRACT

Systems and methods for conducting attribute-based queries over a plurality of objects using bounded memory locations and minimizing costly input and output operations are provided. A plurality of attributes are associated with each object, and a plurality of data groups, one each for the identified attributes are created. The objects associated with the attributes are placed into the appropriate data groups, and the objects contained within each data group are sorted into blocks such that each block within a given attribute contains that objects having the same attribute value. Results to the query are created by loading blocks into a primary memory location in a middleware system and combining the loaded blocks to create the desire query results. Block combinations are created based upon the fit of the given block combination to the query as expressed in an aggregation function. A second dedicated memory location can also be provided to hold multiple block combinations to optimize the order in which blocks are loaded and combined. Empty block buffers and external storage devices can also be provided to further enhance the generation of query results.

### FIELD OF THE INVENTION

The present invention relates to information integration techniques and, more particularly, to the operation of similarity-based searches for information items having multiple feature attributes. It details algorithms that perform online scheduling of item read operations, partial join operations and memory or disk swapping operations to reduce overall response time under a given memory constraint.

### BACKGROUND OF THE INVENTION

Objects stored in multimedia or e-commerce repositories are typically described by a number of feature attributes, for example the color and size of an article of clothing. The objects stored in these repositories typically have identical or overlapping attribute values, e.g., different articles of clothing can have the same size. Typically, these repositories have memory constraints resulting from their use in the context of larger systems, requiring that memory capacity be shared with other concurrent applications.

Common queries over the objects stored in these repositories are targeted at retrieving the k best matching objects with respect to multiple attributes, e.g., finding the 10 best matching shirts having the size XL and color blue. Since many e-commerce and multimedia applications are highly interactive, the results to these queries are provided in an incremental fashion. For example, the first 10-best matches are provided to the requester first and typically within a very short period of time on the order of seconds. Typically, a response time of the order of seconds prohibits an exhaustive search over the entire repository. While the requestor is inspecting the initial grouping of matched results, the next 10-best matches are obtained and held until the requester asks for them.

Different methods have been used to provide for the ranking of the results. One method is the table-based approach. The table-based approach assumes that a complete ranking is given for each one of the feature attributes to be used to generate results to the query. Another approach is the incremental information join approach. Incremental approaches assume that only the first few rankings are known but that more can be acquired at a later time.

When complete rankings of the feature attributes are available in table format, common cost-based optimization techniques can be applied to generate results to the queries and to sort the results based upon the distances of the results to the desired objects. An example of common cost-based optimization techniques is described in Surajit Chaudhuri, “An Overview of Query Optimization in Relational Systems,” Proceedings of the 17th ACM SIGACT-SIGMOD-SIGART Symposium on Principles of Database Systems, pp. 34-43, Seattle, Wash. (1998). The common cost-based optimization techniques, however, have long associated response times, making them unsuitable for an interactive query applications.

Incremental approaches are typically based on Fagin's Algorithm (FA). A description of FA can be found in Ronald Fagin, “Combining Fuzzy Information from Multiple Systems,” Proceedings of the 15th ACM SIGACT-SIGMOD-SIGART Symposium on Principles of Database Systems, pp. 216-226, Montreal, Canada (1996). In FA, each ranked feature attribute is viewed as an incoming stream, and the goal is to generate an outgoing stream of objects whose ranks are computed using a monotonic aggregation function. Accesses to the head of the stream, the next best match for this feature, pay a sorted read cost, whereas accesses to any object in the stream, via object ID, pay a random read cost. FA attempts to minimize the overall number of object reads by assuming that the aggregation function is monotonic and reading k objects sequentially from each stream, where k is the number of desired results to the query. The. monotonicity of the aggregation function guarantees that the overall top-k objects are among those read objects. In order to compute the rank of each read object, random accesses are performed to the streams where that object was not yet seen.

Several improvements of this algorithm were suggested in order to reduce the amount of objects to read sequentially from each incoming stream during query processing. Examples include the Threshold Algorithm (TA) as described in Ronald Fagin, Amnon Lotem, and Moni Naor, “Optimal Aggregation Algorithms for Middleware,” Proceedings of the ACM Symposium on Principles of Database Systems, pp. 102-113 (2001), and the Quick-Combine Algorithm (QA) as described in Ulrich Guntzer, Wolf-Tilo Balke, and Werner Kieβling, “Optimizing Multi-Feature Queries for Image Databases,” Proceedings of the 26th VLDB Conference, pp. 419-428, Cairo, Egypt (2000). Instead of reading k objects from each stream, TA stops reading as soon as k objects are found having an aggregated distance less than a pre-defined threshold. This threshold is computed by combining the distances of the last sequentially read object of each stream. In general, this threshold increases with each sorted read access since the distances are monotonically increasing and the combination function is monotonic. QA uses a similar idea as TA but attempts to reach the termination condition faster. Since the. stream whose distance increases most will cause the highest increase in the threshold value, QA tries to read more objects from this stream.

Other approaches attempt to minimize the number of object reads by combining the index structures of each feature attribute into a common indexing scheme as illustrated, for example, in Paolo Ciaccia, Marco Patella, and Pavel Zezula, “Processing Complex Similarity Queries with Distance-based Access Methods,” Proceedings of the 6th International Conference on Extending Database Technology, pp. 9-23, Valencia, Spain (1998). These approaches are prohibitive in distributed settings. Overall, these approaches try to minimize the number of object accesses but fail to take into account memory constraints and disk/memory swapping costs.

In Surajit Chaudhuri and Luis Gravano, “Optimizing Queries over Multimedia Repositories,” Proceedings of the International Conference on Management of Data, pp. 96-102, Montreal, Quebec, Canada (1996), a hybrid between the table-based approach and the incremental approach is presented. The cost optimization is performed before query execution and may not lead to a query plan with minimal cost since it is based on Fagin's first algorithm. Furthermore, the work is restricted to a small number of aggregation functions and does not easily extend to incremental query processing. For certain data distributions, the algorithm does not read enough objects for each feature attribute and can therefore not yield any result. This problem occurs because the query plan is computed statically before the query execution.

In the pending U.S. patent application Ser. No. 10/137,032 filed Nov. 6, 2003, which is incorporated herein by reference in its entirety, a framework for incrementally joining ranked lists while minimizing response time is presented. That framework, however, does not take memory constraints and disk or memory swapping costs into account but assumes there is always sufficient memory available.

### SUMMARY OF THE INVENTION

The present invention is directed to systems and methods for reducing the response time of ranked multi-feature queries under memory constrained conditions. Methods in accordance with exemplary embodiments of the present invention take into account the cost to retrieve an object from a data source, the cost to swap data between a memory location and an external storage disk, and the cost for in-memory join operations in order to reduce the overall response time. A plurality of block combinations are generated to provide a window of future attribute combinations that can be used to generate query results. Although the block combinations are generated based upon an aggregated ranking, the order in which the combinations are selected to produce query results can be changed. In particular, an order for the block combinations is determined that reduces the expected response time to the query as computed from the current blocks contained in a memory location, the status of the data groups containing the blocks and costs associated with input and output operations.

In addition, an external memory device such as a disk buffer that can store data blocks is used for swapping data in and out of memory. Methods in accordance with exemplary embodiments of the present invention also use an empty block buffer to maintain and track of empty data blocks. Although the empty data buffer can reduce the overall amount of memory available, removing empty blocks from the primary memory location opens memory space to be used for block combinations and accelerates the query process.

### BRIEF DESCRIPTION OF THE DRAWINGS

FIG. 1 is a schematic representation of an embodiment of a system in accordance with exemplary embodiments of the present invention;

FIG. 2 is a flow chart illustrating an embodiment of a process for conducting an attribute-based query in accordance with exemplary embodiments of the present invention;

FIG. 3 is a flow chart illustrating an embodiment of a method for creating memory space for use with exemplary query methods of the present invention;

FIG. 4 is a flow chart illustrating an embodiment of a method for maintaining a look-ahead window for use with exemplary query methods of the present invention;

FIG. 5 is a flow chart illustrating an embodiment of a method for creating partial block combinations;

FIG. 6 is a schematic representation of an embodiment of providing a query containing complete attribute ordering information; and

FIG. 7 is a schematic representation of an embodiment of providing a query without attribute ordering information.

### DETAILED DESCRIPTION

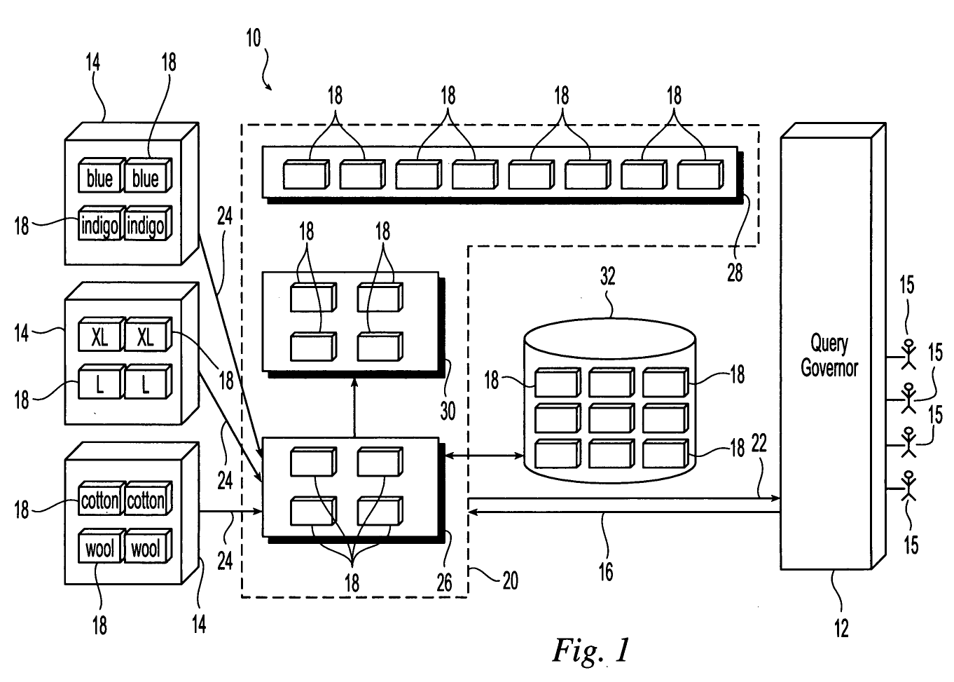

Referring initially to FIG. 1, an embodiment of a system 10 for use with a method for conducting an attribute-based query over a plurality objects in accordance with an exemplary embodiment of the present invention is illustrated. The system 10 includes a query governor 12 and one or more data sources or data groups 14. The query governor 12, which is in communication with one or more users 15, issues queries 16 and presents the results of these queries to the users 15. The query governor 12 also specifies various query parameters for the queries that it issues. These query parameters include an identification of the objects over which the query is to be conducted, the attributes desired in those objects, weights associated with aggregation functions to be used in assembling the objects and any other user-defined query parameter.

The data groups 14 contain the objects over which the queries are conducted. These objects can be any item to which attributes or features can be ascribed. Suitable objects include, but are not limited to, clothing, automobiles, houses, electronics, computer equipment, home furnishings, furniture, appliances, musical recordings, movies, television programs, restaurants and combinations thereof. Although the objects can be randomly disposed within the data groups 14, preferably, the objects are arranged within the data groups to facilitate sorted access to any given set of objects. In one embodiment, each data group is associated with an attribute of the objects over which the query is being conducted. For example, if the query is being conducted over clothing, then data groups are provided for attributes associated with an article of clothing, e.g. type of clothing, size, color, style, material, etc. In addition to being placed within a data group based on a given attribute, the objects contained within each data group are sorted into one or a plurality of blocks 18. Each block 18 within a given data group 14 contains all the objects having the same value for the attribute associated with that data group. Therefore, a given object appears a plurality of data groups 14. Any suitable structure can be used for the data group including multiple rows in a single table disposed in a single database to multiple remote database systems, one each for each object or attribute.

Disposed between the query governor 12 and the data groups 14 and in communication therewith is a query result assembly system 20. The system 20 receives queries 16 form the query governor 12 and returns query results 22 to the query governor 12. The system 20 uses the blocks 18 within the data groups 14 to generate the results to the query, which is typically an attribute-based query in that the query identifies the preferred or desired attributes in the objects. The system 20 is capable of receiving blocks 24 from each data group and of using the received blocks to generate the query results. In order to facilitate receipt of the blocks and assembly of the results, the system 20 includes a memory location or memory buffer area 26. The memory location 26 has a pre-determined size that is preferably a fixed size, i.e. the memory location is capable of storing a pre-defined number of blocks. In addition, the system can alternatively include a second dedicated memory location or look-ahead window 28. As with the first or primary memory location 26, the second dedicated memory location has a pre-determined capacity that is preferably of fixed size. An optional empty block buffer 30 having a fixed size can also be provided in the system 20. In order to provide for additional or overflow storage space, for example, for swapping of blocks that are not needed for current queries, an optional external memory device 32 is provided. Suitable external memory devices include disk drives, e.g. flopping disk drives and hard disk drives, and optical media located external to but in communication with the system 20. In one embodiment, all of the components except for the external memory device 32 are resident within the memory contained in the system 20.

The query governor 12 submits queries including an identification of search parameters and attribute values to the system 12, and the system 20 forwards these queries to the data sources 14 to retrieve blocks of objects 18 that represent the closest match for the desired attribute values. The retrieved blocks are joined together or recombined in the memory buffer area 26 of the system 20 to generated results to the query. If necessary, additional block combinations are identified, and the associated blocks are stored in the look-ahead window 28. In addition, empty data blocks are identified, marked as empty and stored in the empty block buffer 30. As necessary, data blocks are swapped out to or in from the external memory device 32. The generated results are returned to the query governor 12 by the system 20. The order that the results are returned in is determined by an aggregated score or weight associated with each result based upon the values of the attributes used to generate that result.

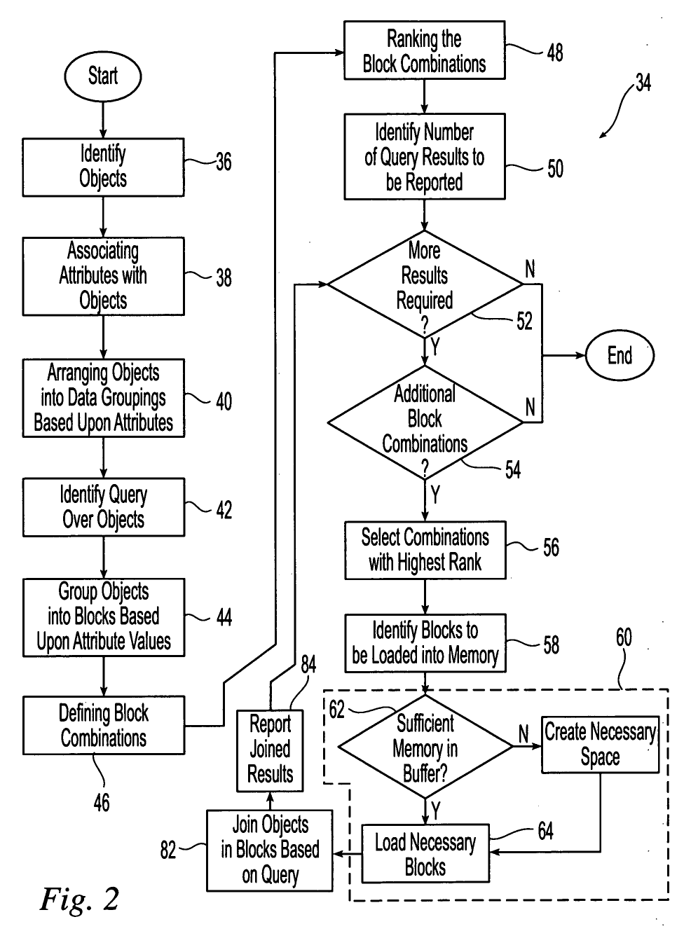

Referring to FIG. 2, an embodiment of a method for conducting an attribute-based query over a plurality of objects 34 in accordance with an exemplary embodiment of the present invention is illustrated. Initially, a plurality of objects over which the query is to be conducted are identified 36. Attributes, for example, color, size, shape, material, price, style or accessories, are associated with the objects 38. In one embodiment, a plurality, d, of attributes are associated with each object. These attributes can be referred to as x₁, . . . , x_{d}. A data group is created for each one of the identified attributes, and the objects are arranged into these data groupings based upon their attributes 40. Therefore, each data grouping contains a list of a plurality of objects. In one embodiment, at least one data group is created for each attribute associated with an object. For example if each object has d attributes associated with it, then d data sources, A₁, . . . , A_{d}, are created. Although the steps of identifying objects 36, associating attributes with these objects 38 and arranging these objects into data groupings 40 can be performed concurrent with a given query, preferably, these steps are performed as pre-computational steps before the query.

One or more attribute-based queries of the objects are identified 42. The attribute-based queries contain an identification of the parameters, for example user-defined parameters, that are desired in the objects. These parameters include the desired values for one or more attributes associated with the objects. Since the attributes associated with each object contain an identification of the type of attribute and a value for that attribute, a variance or distance is defined between the desired attribute value as identified in the query parameters and the attribute values associated with the objects over which the query is conducted. These distances or variances, for example how closely the color of a given object or group of objects matches the desired color, are used to produce results to the attribute-based query.

In order to facilitate the use of these variances, the objects within each data group are sorted into a plurality of blocks 44. Preferably, the objects are sorted using index structures that provide for fast, sorted retrieval of the blocks and objects without incurring additional cost. Examples of suitable index structures include, but are not limited to B-tree and R-tree structures. Each block has a common attribute value for the objects contained within it. This value can be based upon an assigned rank calculated from the identified query. Preferably, each block within a given data group contains the object within that data group that have substantially the same value for the attribute associated with that data group. For example, if the data group is associated with the attribute of size, then suitable blocks are small, medium and large. These blocks are used to generate results for the identified attribute-based query. In one embodiment, each data grouping allows only sorted access, i.e., reading objects in increasing attribute value order; however, the values and their distances for each attribute list are known in advance.

In one embodiment of using the blocks to generate the results to the query, combinations of the blocks are used to generate lists of objects. For example, if the query is looking for blue shirts size large, then blocks are obtained for blue, shirts and large, and objects resulting from the combination of these blocks are identified. Therefore, given the data groupings and blocks contained therein, a plurality of combinations of the blocks are identified 46 such that each combination yields a plurality of objects. Each one of the combinations are ranked 48 in accordance with the distance or variance between the desired attributes values and attributes associated with the resulting objects such that the lower the variance the higher the rank.

In one embodiment, a monotonic aggregation function of the attributes, t(x₁, . . . , x_{d}), is used to determine the top k objects having the shortest aggregated distances, i.e. lowest variance or highest rank, and the attributes associated with those top k objects. A middleware aggregation problem with no random access is discussed in Ronald Fagin, Amnon Lotem, and Moni Naor, “Optimal Aggregation Algorithms for Middleware,” Proceedings of the ACM Symposium on Principles of Database Systems, pp. 102-113 (2001). The algorithm discussed therein, known as Fagin's algorithm, is unsuitable for use with methods in accordance with the present invention for two reasons. First, Fagin's no random access algorithm (NRA) maintains one record for each object that has been seen, and these records need to be updated in each step. Maintaining all these records results in too many I/O operations and has a high storage or memory cost, which is incompatible with systems having low or fixed available memory. Second, the NRA is constructed for cases where the attributes are different for all the objects. Often, however, many objects share the same attribute value, e.g., many shirts have the size XL. The block-based algorithm in accordance with the present invention is better suited for conducting queries using limited memory space and on blocks of objects having common attribute values.

The number of query results or objects to be reported are identified 50. Results to the query are then generated until the number of desired query results is reached or there are no more results available. Therefore, a determination of whether or not more results are needed is made 52. If no more results are needed, then the process of generating objects is stopped. If the number of results has not been exceeded, then a determination is made about whether any additional block combinations are available 54 for generating results. If no more results are available, then the process is stopped. If additional results, i.e. additional block combinations, are available, then the process selects another block combination. In one embodiment, the bock combination having the highest rank, that has not already been used, is selected 56.

In one embodiment, the plurality of blocks contained in data group or attribute list Aᵢ are denoted by Aᵢ[1], Aᵢ[2], . . . . Aᵢ[d]. The distances of these blocks or the variance of the attribute values contained in each one of these blocks from the desired value for the attribute associated with that data group are sᵢ[1], sᵢ[2], . . . , sᵢ[d]. Preferably, the assumption is made that sᵢ[1]≦sᵢ[2]≦ . . . . ≦sᵢ[d]. A block-based combination or join is denoted by a d-tuple J=(j₁, . . . , j_{d}), which represents the join of blocks A₁[j₁], . . . , A_{d}[j_{d}]. The result of the aggregation function, t, applied to these blocks is t(J)=t(s₁[j₁], . . . , s_{d}[d]) and is referred to as the distance or variance of J. Selecting the block combination having the highest rank, can be achieved by selecting the combination having the lowest distance or variance. In one embodiment, the distances, sᵢ[j] associated with all of the blocks are known in advance, and all possible block combinations can be enumerated by the non-decreasing order of these distances.

In one embodiment, the resulting objects are created using blocks of objects stored in a memory location having a pre-determined size. Therefore, once the combination having the highest rank is selected, the blocks used in this combination are identified. Some of these blocks may already be resident in one of the memory locations of the system, and other blocks may need to be loaded into one of the memory locations. Therefore, the blocks that need to be loaded into one of the memory locations are identified 58. The blocks associated with the selected combination are then placed into a memory location 60. Placing the blocks into the memory location includes loading blocks into the memory location from the data groups, swapping blocks from the memory location to an external memory device, moving blocks to an empty block buffer, discarding blocks from the memory location and combinations thereof. In one embodiment as illustrated in FIG. 2, in order to place the necessary blocks in the primary memory location, this memory location is analyzed to determine if sufficient memory exists 62. If sufficient memory exists, then the blocks are loaded or placed into the memory location 64. If sufficient memory space is not available, then the necessary amount of additional space is created 66, and then the necessary blocks are loaded into memory.

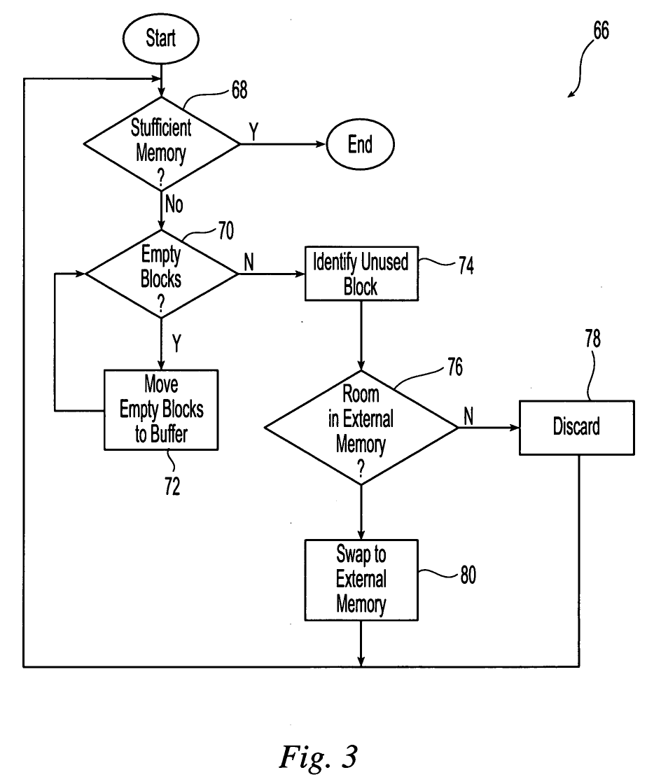

Referring to FIG. 3, an exemplary embodiment for creating the necessary space in the memory location 66 is illustrated. As illustrated, the steps are run in an iterative loop using an initial check for a sufficient amount of memory 68. As long as the amount of space in the memory location is not sufficient to load the blocks, a check of the existing blocks within the memory location is made to determine if any of the blocks are empty 70. If any empty blocks exist, these blocks are moved to the empty block buffer 72. If all of the empty blocks have been moved or no such empty blocks exists, then blocks contained in the memory location that are not required for the current block combination are identified 74. A check of the external memory device is made to determine if sufficient memory exists to hold the unused blocks 76. If sufficient memory exists, then the unused blocks are moved to the external memory device 80. If sufficient external memory does not exist, then the unused blocks can be discarded 78.

Referring again to FIG. 2, having placed the necessary blocks in the memory location, these blocks are joined in accordance with the selected combination to yield the resulting objects in accordance with the identified query 82. The resulting objects are then reported 84. Therefore, the method in accordance with an exemplary embodiment of the present invention produces results to the attribute-based query using a memory location of a pre-determined size, decreasing the memory and storage requirements associated with conducting the query.

In addition to reducing the memory requirements associated with conducting the query, methods and systems in accordance with exemplary embodiments of the present invention minimize the overall number of loads and swaps required to produce the query results. In general, the problem of reducing the number of loads and swaps is NP-hard when the number of attributes d≧4. Due to this hardness result, methods in accordance with the present invention use the number of buffer misses, i.e. the number of new blocks that need to be loaded into the memory location, as a factor in selecting the next block combination. In one embodiment, the blocks that are currently in memory and the blocks having to be loaded into or swapped out of memory are analyzed.

In one embodiment, the memory location, having a predetermined size, can hold at most M objects contained in the blocks. Since blocks of objects are loaded into the memory location before any join operations are performed, exemplary methods in accordance with the present invention provide for the creation of sufficient space in the memory location. In one embodiment when the memory location is substantially full, the external memory device is used to swap objects in and out. These swapping operations, both in and out, are referred to as I/O's. In one embodiment, each I/O operation reads or writes a block containing at most about B objects. These block-based sorted accesses are referred to as loads, and each load operation reads a block containing up to about B objects. Since the cost of loads varies from application to application, accounting for each load is handled separately. The overall efficiency of methods conducted in accordance with exemplary embodiments of the present invention is measured using the number of loads, the number of I/O's, the number of joins and the overall running time of the algorithm used to generate the results. Therefore, cost can be minimized by minimizing the number of I/O's, the number of joins and the overall running time of the algorithm.

Methods for generating results to the attribute-based queries in accordance with exemplary embodiments of the present invention generate a sequence of load, swap and join operations that return the top-k objects while reducing the overall response time. This overall response time is computed as the sum of the time for each operation in the sequence. For example, if the sequence is “load a block from data group 1, load a block from data group 2, swap in block 7 for external storage device and join blocks 3 and 7″, then the overall time is the summation of the time for 2 loads, 1 swap, and 1 join operation.

Since load is the most costly operation, the number of loads or accesses to the data groups are preferably minimized. In one embodiment, a join or block combination having the highest rank or minimum distance that has not already been used is selected, and the required blocks are placed, i.e. loaded or swapped, in the memory location so that the necessary join can be performed in system memory to create the results to the query. When an insufficient amount of memory exists in the primary memory location to swap in or load blocks, one or more blocks are discarded or swapped out. Since multiple combinations can have the same rank and blocks that are discarded or swapped out for a first combination may be needed later for a second combination having substantially the same rank as the first combination, methods in accordance with exemplary embodiments of the present invention provide for the manipulation of multiple combinations to minimize the number of loads.

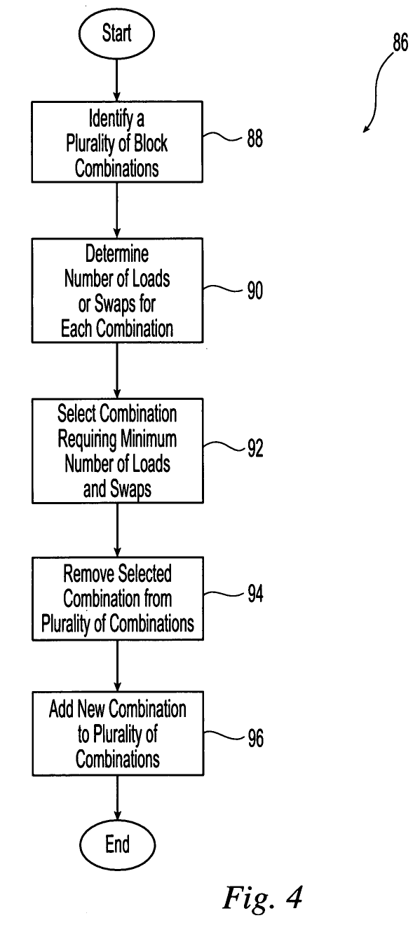

Referring to FIG. 4, one embodiment of a method for maintaining and manipulating a plurality of block combinations for selection 86 is illustrated. This method can also be viewed as maintaining a look-ahead window for subsequent block combinations. As illustrated, a plurality of block combinations are identified 88. Preferably, each one of the plurality of block combinations has an equivalent rank, such as the next highest rank. In one embodiment, a pre-determined number of block combinations are identified. Blocks associated with these plurality of block combinations are stored or maintained in a dedicated memory location separate from the primary memory location used to execute the join functions. Once the plurality of block combinations are identified, the number of loads or swaps required for each combinations are determined 90, and the combination requiring the minimum number of loads and swaps is selected 92. This selected combination is removed from the plurality of identified combinations 94, and a new block combination is identified and added to the plurality of combinations 96.

In one embodiment, in addition to considering a single block combination having the fewest associated loads and swaps, the number of loads and swaps associated with the sequence of selection of the plurality of block combinations is considered. This embodiment is particularly useful when each combination in the plurality of identified combinations has substantially the same rank. Considering the overall sequence of selecting the plurality of combinations accounts for blocks that may be swapped or discarded initially that may be required, i.e. loaded, for subsequent combinations. In general, this heuristics keeps blocks in memory that are needed in the near future, reducing the cost due to expensive swapping and re-loading operations.

The effective length or size of the look-ahead window can be expanded by the selection of the notation used for the block combinations. In one embodiment, a notation, for example “*” is introduced to represent all blocks not yet accessed from a particular data group. For example, if d=3, and blocks 2, 2 and 3 were already loaded from the three data sources, respectively, then (1, 2, *) represents joins (1, 2, 4), (1, 2, 5), . . . , and (2, *, *) represents all possible joins that involve A₁[2], one of A₂[3], A₂[4], . . . and one of A₃[4], A₃[5], . . . . Therefore, when blocks are placed in the memory location, an identification of the current block in the selected combination and an identification of blocks in each attribute that have not yet been accessed are placed into the memory location.

When a block combination is added to the dedicated memory location or look-ahead window, each “*” is interpreted as the next block to be loaded from the corresponding data group. For example, (1, 2, *) as given above is interpreted as (1, 2, 4), and (2, *, *) is interpreted as (2, 3, 4), because all other joins represented by (2, *, *) would be selected ahead of (2,3,4) due to the fact that the ranks of these blocks combinations are no greater than (2, 3, 4) as provided by the monotonicity of the aggregation function and the same number of buffer misses associated with (2, 3, 4) will be associated with subsequent block combinations since their already loaded part (A₁[2] in this example) is the same as (2, 3, 4) and subsequent combinations yield the same number of unloaded blocks. Therefore, only these block combinations are considered when choosing the next combination to be performed, increasing the effective length of the look-ahead window. The determination of which blocks to move or swap to the external storage device is not affected by the use of this notation, because if a block is in the memory location, that block was loaded from the data group and will not be covered by any of the “*”, which indicate blocks that have not yet been loaded.

In one embodiment, to apply these representations an initial representation of (*, *, *) is used, and the block representations are updated as block combinations are selected from the data groups. When A₁[j] is selected and placed in the primary memory location, all block combinations having a “*” as their ith element are split into j and “*”. For example, if A₃[4] is loaded in the example discussed above, (1, 2, *) is split into (1, 2, 4) and (1, 2, *), and (2, *, *) is split into (2, *, 4) and (2, *, *). Therefore, each pending join is covered by only one representation. Using this notation in accordance with the present invention, only the block combinations that have the same next lowest distance are materialized, and subsequent block combinations are computed at a later time as needed or desired. In addition, use of this notation alleviates the need to know the distances or ranks of all blocks or block combinations in advance at the same time.

In one embodiment, partial combination results are used to further enhance the computational and storage efficiency of methods in accordance with exemplary embodiments of the present invention. Subcombinations of blocks, for example 2-way sub-combinations, are often used multiple times by different full block combinations. As an example, the result of joining blocks A₁[1] and A₂[2] can be reused for all joins of the form (1, 2, *). The use of subcombinations of blocks reduces the numbers of I/O's and saves memory storage space since the partial results or subcombinations are often significantly smaller than the individual blocks.

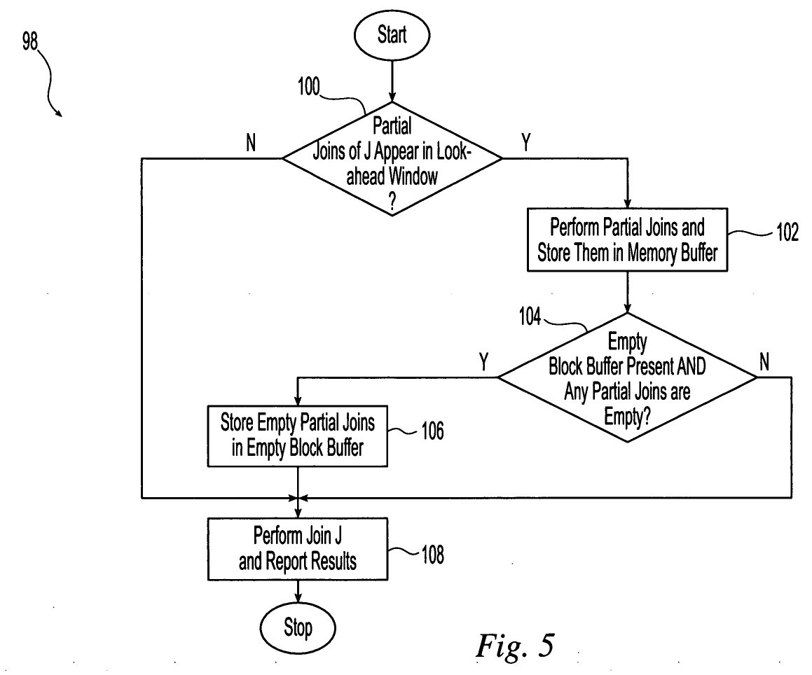

Referring to FIG. 5, an embodiment for identifying subcombinations of blocks common to two or more block combinations 98 is illustrated. This embodiment utilizes subcombinations, for example 2-way joins, and stores these subcombinations in the primary memory location or secondary dedicated memory location for the look-ahead window. As illustrated, before a complete block combination is conducted, all of the potential combinations, for example all of the potential block combinations contained in the look-ahead window, are analyzed to determine if there are any subcombinations common to two or more of the complete block combinations 100. If a common subcombination is located, this subcombination is computed and stored in memory 102. In the embodiment as illustrated, the computed subcombination is stored in the primary memory location. Therefore, steps are taken to provide for adequate storage space in the memory location. For example, if an empty block buffer is present and there are empty subcombinations 104, then these empty subcombinations are moved to the empty block buffer 106. Empty subcombinations include subcombinations that are no longer required or will not be used in subsequent full block combinations. Alternatively, 2-way join turns that yield an empty result are stored in a special optional empty join memory buffer. In one embodiment, full block combinations that contain an empty 2-way join are not be considered when identifying potential combinations, thereby pruning the search space. Once the subcombinations are computed and stored in the memory location, the full block combinations are performed, and the results are reported 108.

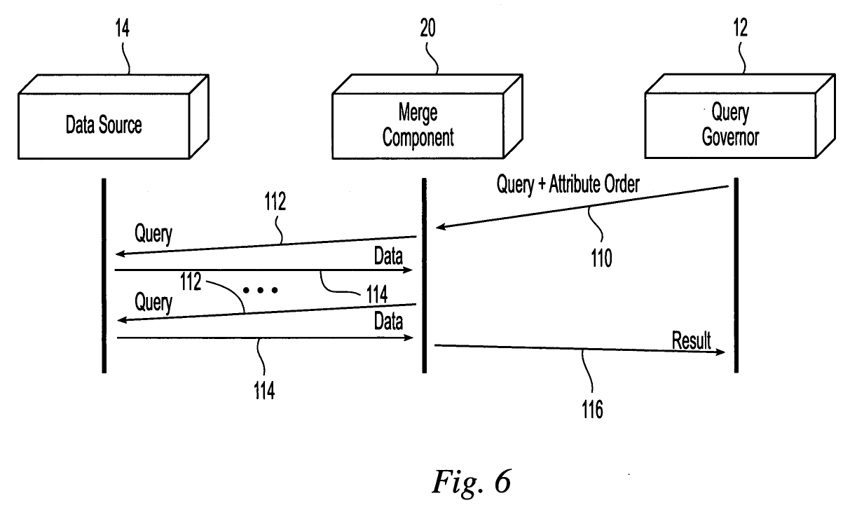

The query provided by the query governor includes query parameters including an identification of the desired objects, the attributes required in these objects and the ordering of the values of these attributes. The ordering of the attribute values includes an identification of which attributes are most important and the order in which attribute values are desired. For example, the ordering of attributes could indicate that the size must be large and that the preferred colors are blue, yellow and green or that various shades of blue are desired before other colors. In one embodiment, as illustrated by FIG. 6, complete attribute ordering information is provided with the query. As illustrated, the query governor receives an initial query containing complete attribute ordering information 110 to the merge component 20. In response, the merge component issues a plurality of queries 112 to the data groups 14, and receives data 114, i.e., object blocks, from the data sources 14. The merge component uses these object blocks in the appropriate combinations to create results that are returned to the query governor 116.

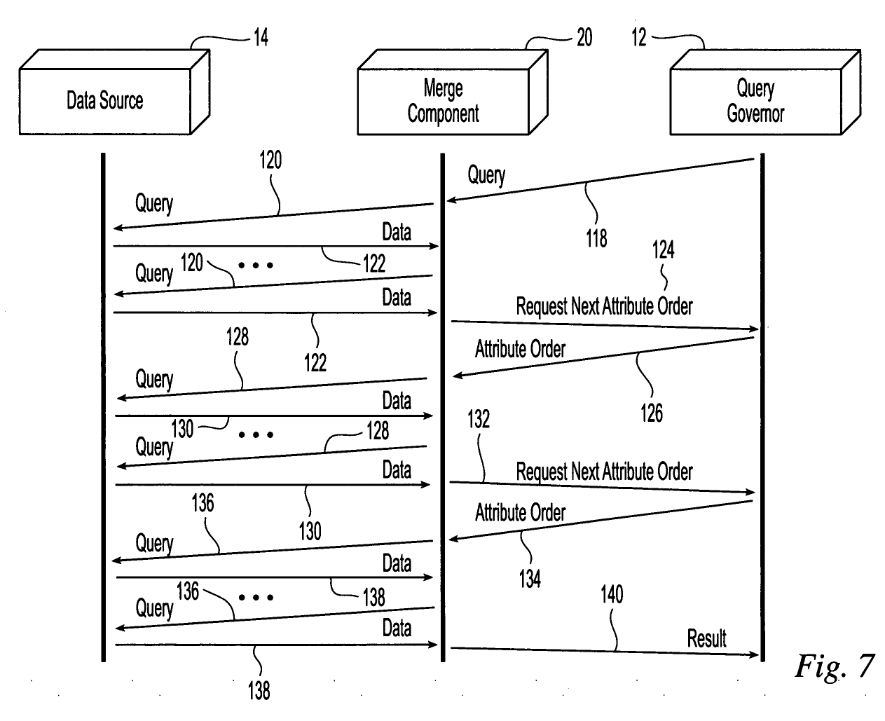

In another embodiment as illustrated in FIG. 7, the query governor 12 only provides the query and allows for call-backs from the merge component 20 to request further ordering on demand. As illustrated, the query governor 12 forwards only an initial query 118 to the merge component 20. The merge component 20 then issues a plurality of initial queries 120 to the data groups 14 and receives initial objects blocks 122 until more ordering information is needed to continue selecting the blocks. Then, a request for further ordering information 124 is sent to the query governor 12, which returns more ordering information to the invention 126. The merge component 20 sends a second set of queries 128 to the data sources 14 and receives a second set of object blocks 130 again until more attribute ordering information is needed. A second request for further ordering information 132 is sent to the query governor 12, which returns more ordering information to the invention 134. The merge component 20 then produces a third set of queries 136 and receives a third set of object blocks 138. The process of sending queries, receiving blocks and requesting additional ordering information is repeated iteratively until a result is ready to be returned 140 to the query governor 12.

The present invention is also directed to a computer readable medium containing a computer executable code that when read by a computer causes the computer to perform a method for conducting an attribute-based query over objects in accordance with exemplary embodiments of the present invention and to the computer executable code itself. The computer executable code can be stored on any suitable storage medium or database, including databases in communication with and accessible by the query governor 12, the merge component 20 or the data sources 14, and can be executed on any suitable hardware platform as are known and available in the art.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

What is claimed is:

1. A method for conducting an attribute-based query over objects, the method comprising:
identifying a plurality of objects, each object having one or more associated attributes;
creating a data group for each attribute, each data group comprising a list of objects;
sorting the objects in each data group into a plurality of blocks, each block within a given data group comprising objects having a same value for that attribute; and
using the blocks to generate results to an attribute-based query over the plurality of objects.

2. The method of claim 1, wherein the step of creating data groups comprises creating at least one data group for each attribute.

3. The method of claim 1, wherein the attribute-based query comprises an identification of desired attribute values and the step of using the blocks to generate results comprises:
defining a plurality of combinations of blocks, each combination yielding a plurality of resulting objects;
ranking each combination in accordance with a variance between the desired attribute values and attributes associated with the resulting objects such that the lower the variance the higher the rank; and
selecting a highest ranked combination.

4. The method of claim 3, further comprising:
placing blocks associated with the selected highest ranked combination in a primary memory location of pre-determined size; and
joining the associated blocks placed in the primary memory location in accordance with the selected combination to yield the resulting objects.

5. The method of claim 4, wherein the step of placing the blocks in the memory location comprises loading blocks into the primary memory location from the data groups, swapping blocks from the primary memory location to an external memory device, moving blocks to an empty block buffer, discarding blocks from the memory location or combinations thereof.

6. The method of claim 3, wherein the step of selecting the highest ranked combination further comprises:
identifying a plurality of potential combinations having an equivalent highest rank; and
selecting one of the plurality of potential combinations such that the number of input and output operations required to yield the resulting objects are minimized.

7. The method of claim 6, wherein the step of identifying a plurality of potential combinations comprises identifying a pre-determined number of combinations.

8. The method of claim 7, further comprising maintaining blocks associated with the pre-determined number of potential combinations in a secondary dedicated memory location.

9. The method of claim 4, wherein the step of placing blocks in the primary memory location comprises for each block placing an identification of a current block in the selected combination and an identification of blocks in each attribute that have not yet been accessed.

10. The method of claim 6, further comprising identifying subcombinations of blocks common to two or more combinations in the plurality of potential combinations and placing the subcombinations in the primary memory location.

11. The method of claim 3, further comprising providing complete attribute ordering information with the query.

12. A computer readable medium containing a computer executable code that when read by a computer causes the computer to perform a method for conducting an attribute-based query over objects, the method comprising:
identifying a plurality of objects, each object having one or more associated attributes;
creating a data group for each attribute, each data group comprising a list of objects;
sorting the objects in each data group into a plurality of blocks, each block within a given data group comprising objects having a same value for that attribute; and
using the blocks to generate results to an attribute-based query over the plurality of objects.

13. The computer readable medium of claim 12, wherein the step of creating data groups comprises creating at least one data group for each attribute.

14. The computer readable medium of claim 12, wherein the attribute-based query comprises an identification of desired attribute values and the step of using the blocks to generate results comprises:
defining a plurality of combinations of blocks, each combination yielding a plurality of resulting objects;
ranking each combination in accordance with a variance between the desired attribute values and attributes associated with the resulting objects such that the lower the variance the higher the rank; and
selecting a highest ranked combination.

15. The computer readable medium of claim 14, further comprising:
placing blocks associated with the selected highest ranked combination in a primary memory location of pre-determined size; and
joining the associated blocks placed in the primary memory location in accordance with the selected combination to yield the resulting objects.

16. The computer readable medium of claim 15, wherein the step of placing the blocks in the memory location comprises loading blocks into the primary memory location from the data groups, swapping blocks from the primary memory location to an external memory device, moving blocks to an empty block buffer, discarding blocks from the memory location or combinations thereof.

17. The computer readable medium of claim 14, wherein the step of selecting the highest ranked combination further comprises:
identifying a plurality of potential combinations having an equivalent highest rank; and
selecting one of the plurality of potential combinations such that the number of input and output operations required to yield the resulting objects are minimized.

18. The computer readable medium of claim 17, wherein the step of identifying a plurality of potential combinations comprises identifying a pre-determined number of combinations.

19. The computer readable medium of claim 18, further comprising maintaining the blocks associated with the pre-determined number of potential combinations in a secondary dedicated memory location.

20. The computer readable medium of claim 15, wherein the step of placing blocks in the primary memory location comprises for each block placing an identification of a current block in the selected combination and an identification of blocks in each attribute that have not yet been accessed
